(19) United States
(12) Patent Application Publication
(10) Pub. No.: US 2016/0099843 A1
(43) Pub. Date: Apr. 7, 2016

(54) INTERSYSTEM AUTOMATED-DIALOG AGENT

(71) Applicant: Bank of America Corporation, Charlotte, NC (US)

(72) Inventors: Sundar Krishnamoorthy, East Windsor Township, NJ (US); Suresh G. Nair, Robbinsville Township, NJ (US); Veena K. Jagadeesha, Monmouth Junction, NJ (US); Devi S. Kumar, West Windsor Township, NJ (US)

(21) Appl. No.: 14/503,766

(22) Filed: Oct. 1, 2014

(51) Int. Cl. H04L 12/24; G06F 17/28; G06Q 20/10; G06F 3/0484; H04L 29/08

(52) U.S. Cl. CPC H04L 41/22; G06F 3/04842; G06F 3/04847; H04L 67/10; G06Q 20/10; G06F 17/28

(57) ABSTRACT

A computing platform may receive, from a user device, data comprising a natural-language response input by a user, via the user device, in response to a natural-language prompt generated by the computing platform. The computing platform may determine, based on the data, a recommended action for the user. The computing platform may generate, based on the data, a natural-language response to the natural-language response input by the user. The natural-language response to the natural-language response input by the user may identify the recommended action. In some embodiments, the computing platform may determine a recommended next action for the user. In such embodiments, the computing platform may generate a natural-language prompt identifying the recommended next action, and may communicate, to the user device, the natural-language prompt identifying the recommended next action.

### BACKGROUND

Many organizations utilize numerous different computing systems, for example, to maintain records, support internal and external communication and collaboration, analyze data regarding aspects of their operations, and the like. Frequently, a user (e.g., an employee, customer, partner, supplier, or other stakeholder of the organization, or the like) will need to interact with multiple different computing systems of the organization in order to perform a particular task. As a result, what once may have been a relatively straightforward undertaking (e.g., an endeavor involving only a few user-system interactions, often with only one computing system), may now involve a complex series of interactions with multiple different computing systems. These complexities often produce inefficiencies, for example, users may waste time figuring out how to perform tasks, training other users, or the like. Moreover, for a wide variety of reasons (e.g., technology changes, security concerns, business demands, system integration, or the like), organizations are often reconfiguring aspects of their computing systems, which may exacerbate these inefficiencies. Previous attempts to address these inefficiencies have fallen short. Accordingly, a need exists for an improved intersystem automated-dialog agent.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may receive, from a user device, data indicating that a user has invoked an automated-dialog agent. In some embodiments, the automated-dialog agent may comprise a client-side component and a server-side component, and the user may have invoked the client-side component. The computing platform may determine whether an instance (e.g., a process, object, thread, or the like), of the server-side component, associated with the data (e.g., associated with the user device, the user, the client-side component, or the like) is executing on the computing platform. Responsive to determining that the instance is executing on the computing platform, the computing platform may identify the executing instance. Responsive to determining that the instance is not executing, the computing platform may initiate the instance (e.g., instantiate, execute, schedule, change thread context, or the like) and identify the initiated instance.

In some embodiments, the data may comprise a natural-language response input by the user (e.g., via the client-side component) in response to a natural-language prompt generated by the automated-dialog agent (e.g., by the client-side component and/or the server-side component). The data may comprise contextual information. In some embodiments, a graphical user interface (GUI) element associated with the client-side component may be displayed by the user device. In such embodiments, the user device may have displayed the prompt via the GUI element associated with the client-side component, and the contextual information may comprise information displayed by the user device via one or more GUI elements distinct from the GUI element associated with the client-side component.

In some embodiments, the computing platform (e.g., the server-side component) may determine, based on the data, a recommended action for the user. In such embodiments, the computing platform may generate a natural-language response to the natural-language response input by the user, and the natural-language response to the natural-language response input by the user may identify the recommended action. The computing platform may communicate, to the user device (e.g., to the client-side component), the natural-language response to the natural-language response input by the user (e.g., the response identifying the recommended action), and the user device may display (e.g., via the GUI element associated with the client-side component) the natural-language response to the natural-language response input by the user.

In some embodiments, the computing platform may identify, based on the data, an application for implementing the recommended action. In such embodiments, the application may be executing on a computing system distinct from both the user device and the computing platform.

In some embodiments, the computing platform may identify a plurality of inputs to the application for implementing the recommended action. In such embodiments, the computing platform may parse the contextual information, to identify at least a portion of the plurality of inputs.

In some embodiments, the computing platform may determine that one or more inputs, from amongst the plurality of inputs (e.g., the inputs to the application for implementing the recommended action), are not included in the at least a portion of the plurality of inputs (e.g., the input(s) identified by parsing the contextual information). In such embodiments, the computing platform may identify the input(s) that are not included and may generate a natural-language prompt for the input(s). The computing platform may communicate to the user device (e.g., via the client-side component) the natural-language prompt for the input(s), the user device may display (e.g., via the GUI element associated with the client-side component) the natural-language prompt for the input(s), and the computing platform may receive the input(s) from the user device (e.g., from the client-side component).

In some embodiments, the computing platform may invoke an instance of the application (e.g., for implementing the recommended action) and may communicate, to the instance, at least a portion of the plurality of inputs (e.g., one or more of the input(s) identified by parsing the contextual information and/or the input(s) received from the user device in response to the natural-language prompt).

In some embodiments, the application may comprise a terminal-based application hosted by the computing system. In such embodiments, the automated-dialog agent (e.g., the client-side component) may input, into a terminal session executing on the user device, the at least a portion of the plurality of inputs (e.g., one or more of the input(s) identified by parsing the contextual information and/or the input(s) received from the user device in response to the natural-language prompt), and the user device may communicate, to the computing system and via the terminal session, the at least a portion of the plurality of inputs.

In some embodiments, the application may comprise a web-based application hosted by the computing system. In such embodiments, the automated-dialog agent (e.g., the client-side component) may input, into a web browser executing on the user device, the at least a portion of the plurality of inputs (e.g., one or more of the input(s) identified by parsing the contextual information and/or the input(s) received from the user device in response to the natural-language prompt), and the user device may communicate, to the computing system and via the web browser, the at least a portion of the plurality of inputs. Additionally or alternatively, the automated-dialog agent (e.g., the server-side component) may communicate the at least a portion of the plurality of inputs to the computing system, and the computing system may generate a webpage element comprising one or more of the at least a portion of the plurality of inputs and may communicate the webpage element to the user device (e.g., for display via a web browser executing on the user device).

In some embodiments, the instance may comprise an application executing on the user device and in communication with a corresponding application executing on the computing system. In such embodiments, the automated-dialog agent may communicate (e.g., from the server-side component to the client-side component) the at least a portion of the plurality of inputs (e.g., one or more of the input(s) identified by parsing the contextual information and/or the input(s) received from the user device in response to the natural-language prompt), the automated-dialog agent (e.g., the client-side component) may input the at least a portion of the plurality of inputs into the instance, and the instance may communicate the at least a portion of the plurality of inputs to the corresponding application, which may generate an interface element comprising one or more of the at least a portion of the plurality of inputs and may communicate to the user device the interface element (e.g., for display via the instance). Additionally or alternatively, the automated-dialog agent (e.g., the server-side component) may communicate the at least a portion of the plurality of inputs to the computing system, the computing system may input the at least a portion of the plurality of inputs into the corresponding application, the corresponding application may generate an interface element comprising one or more of the at least a portion of the plurality of inputs, and the computing system may communicate the interface element to the user device (e.g., for display via the instance).

In some embodiments, the computing system may comprise a virtualization platform hosting a virtual computing environment comprising the instance. In such embodiments, the automated-dialog agent (e.g., the server-side component) may communicate the at least a portion of the plurality of inputs (e.g., one or more of the input(s) identified by parsing the contextual information and/or the input(s) received from the user device in response to the natural-language prompt) to the computing system, the virtualization platform may communicate the at least a portion of the plurality of inputs to the virtual computing environment, may input, within the virtual computing environment, the at least a portion of the plurality of inputs into the instance, may generate, within the virtual computing environment, an interface element comprising one or more of the at least a portion of the plurality of inputs, and may generate data comprising a rendering, of at least a portion of the virtual computing environment, comprising the interface element, and the computing system may communicate the data comprising the rendering to the user device (e.g., for display via an application executing on the user device).

In some embodiments, the virtual computing environment may comprise a terminal session in communication with a terminal-based application hosted by a different computing system, which may be distinct from the computing platform, the user device, and the computing system (e.g., the virtualization platform). In such embodiments, the at least a portion of the virtual computing environment may comprise the terminal session, and the virtualization platform may input, within the virtual computing environment, the at least a portion of the plurality of inputs into the terminal session, may communicate the at least a portion of the plurality of inputs to the different computing system via the terminal session, and may receive the data comprising the one or more of the at least a portion of the plurality of inputs from the different computing system via the terminal session.

In some embodiments, the instance may comprise an application, executing within the virtual computing environment, in communication with a corresponding application executing on a different computing system, which may be distinct from the computing platform, the user device, and the computing system (e.g., the virtualization platform). In such embodiments, the at least a portion of the virtual computing environment may comprise at least a portion of an interface of the application in communication with the corresponding application, and the virtualization platform may input, within the virtual computing environment, the at least a portion of the plurality of inputs into the application in communication with the corresponding application, may communicate the at least a portion of the plurality of inputs to the different computing system, and may receive data, generated by the corresponding application, comprising the one or more of the at least a portion of the plurality of inputs.

In some embodiments, the automated-dialog agent (e.g., the server-side component and/or the client-side component) may generate a natural-language prompt, which may be displayed by the user device (e.g., via the GUI element associated with the client-side component), prompting the user to confirm the recommended action. In such embodiments, the automated-dialog agent may receive confirmation from the user and, responsive to receiving the confirmation, may instruct the instance to perform the recommended action.

In some embodiments, the automated-dialog agent, may receive, from a different user device (e.g., a different user), data comprising information identifying an issue (e.g., an issue with a similar recommended action and/or natural-language response previously communicated by the automated-dialog agent to the different user device), may identify (e.g., based on the different user, the different user device, the similar recommended action and/or natural-language response, or the like) a user device associated with an associate (e.g., a relevant technical associate, a subject-matter expert, a manager of the different user, or the like) of an organization utilizing the automated-dialog agent, may communicate the data comprising the information identifying the issue, which may include a transcript generated by the automated-dialog agent (e.g., a transcript comprising the similar recommended action and/or natural-language response) to the user device associated with the associate, may receive an update to the automated-dialog agent (e.g., an update related to the similar recommended action and/or natural-language response, and/or an update configured to address the issue) from the user device associated with the associate, and may update the automated-dialog agent in accordance with the update (e.g., to address the issue). In such embodiments, the recommended action for the user may be determined based on the update. Additionally or alternatively, the natural-language response to the natural-language response input by the user may be determined based on the update.

In some embodiments, the automated-dialog agent (e.g., the server-side component) may determine a recommended next action for the user, may generate a natural-language prompt identifying the recommended next action, and may communicate to the user device (e.g., the client-side component) the natural-language prompt identifying the recommended next action (e.g., for display via the GUI element associated with the client-side component).

In some embodiments, the automated-dialog agent (e.g., the server-side component) may receive, from the user device, data comprising natural-language comprising one or more predetermined keywords associated with the automated-dialog agent. In such embodiments, the automated-dialog agent (e.g., the server-side component) may identify a function, of the automated-dialog agent, corresponding to at least one of the one or more predetermined keywords, and the automated-dialog agent (e.g., the server-side component) may invoke the function (e.g., via the client-side component).

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment in accordance with one or more example embodiments; and

FIG. 4 depicts multiple illustrative methods in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

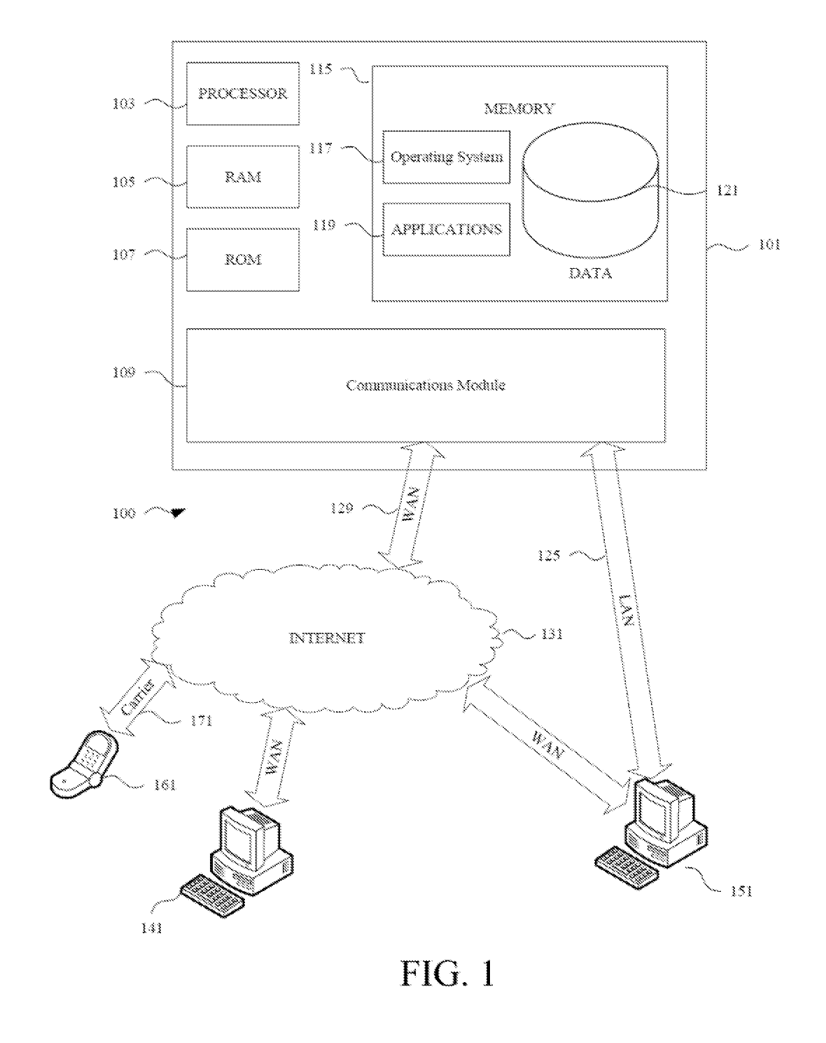

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

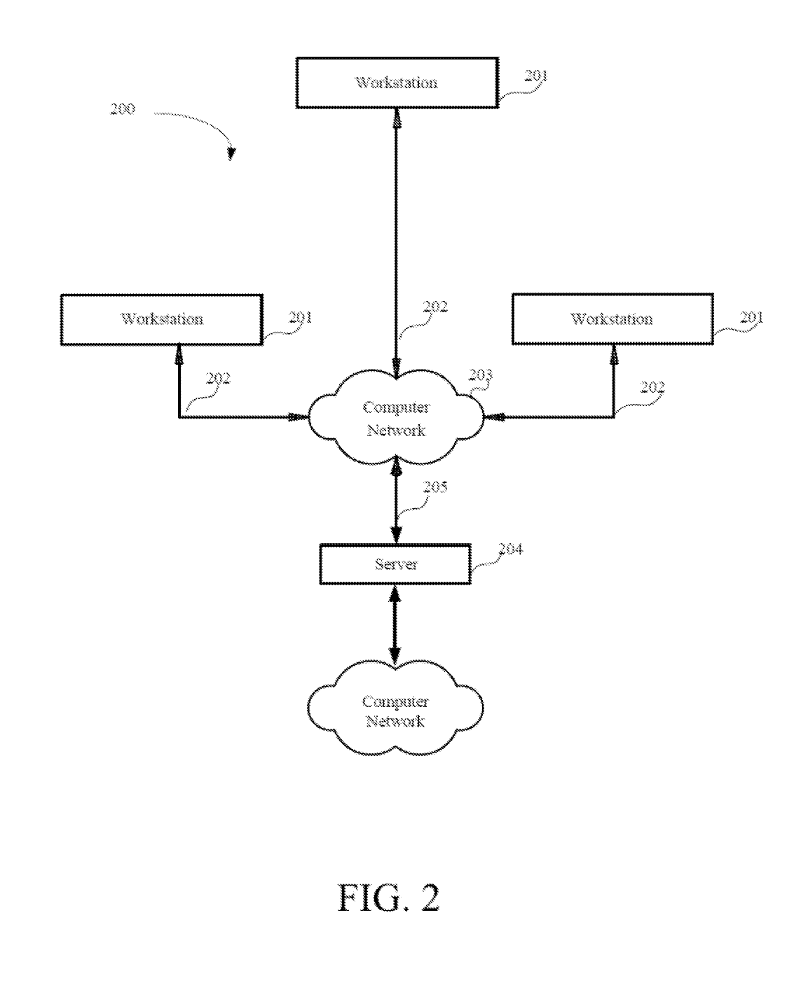

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

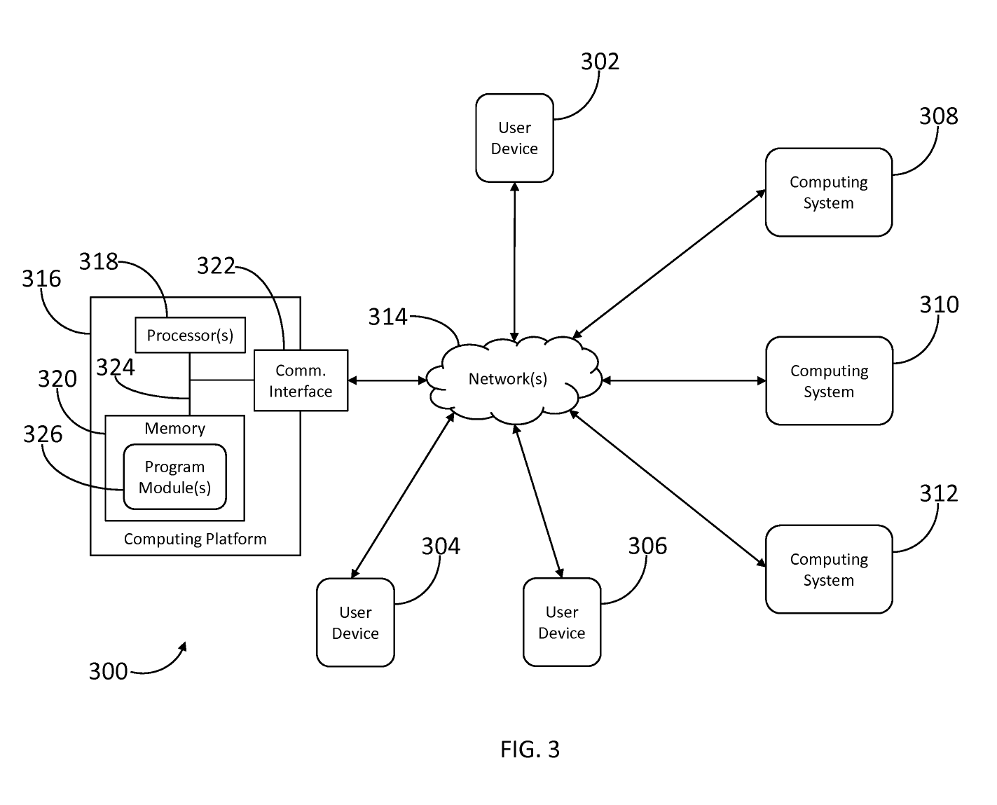

FIG. 3 depicts an illustrative computing environment in accordance with one or more example embodiments. Referring to FIG. 3, computing environment 300 may be associated with an organization (e.g., a corporation, university, government entity, financial institution, or the like) and may include one or more computing devices. For example, computing environment 300 may include user device 302, user device 304, and user device 306. User device 302, user device 304, and/or user device 306 may comprise one or more of any type of computing device (e.g., desktop computer, laptop computer, tablet computer, smart phone, server, server blade, mainframe, virtual machine, or the like) configured to perform one or more of the functions described herein. Computing environment 300 may also include one or more computing systems. For example, computing environment 300 may include computing system 308, computing system 310, and computing system 312. Computing system 308, computing system 310, and/or computing system 312 may include one or more of any type of computing device (e.g., desktop computer, laptop computer, tablet computer, smart phone, server, server blade, mainframe, virtual machine, or the like) configured to perform one or more of the functions described herein. Computing system 308, computing system 310, and/or computing system 312 (e.g., one or more of the computing device(s) therein) may support one or more resources of the organization (e.g., databases, web servers, business applications, communication applications, financial management applications, securities trading platforms, file access or sharing systems, or the like). Computing environment 300 may also include one or more networks. For example, computing environment 300 may include network(s) 314, which may include one or more sub-networks (e.g., LANs, WANs, VPNs, or the like) and may interconnect one or more of user device 302, user device 304, user device 306, computing system 308, computing system 310, or computing system 312.

Computing environment 300 may also include one or more computing platforms. For example, computing environment 300 may include computing platform 316. Computing platform 316 may include one or more of any type of computing device (e.g., desktop computer, laptop computer, tablet computer, smart phone, server, server blade, mainframe, virtual machine, or the like) configured to perform one or more of the functions described herein. In some embodiments, computing platform 316 may include one or more of user device 302, user device 304, user device 306, computing system 308, computing system 310, or computing system 312. Computing platform 316 may include one or more processor(s) 318, memory 320, communication interface 322, and/or data bus 324. Data bus 324 may interconnect processor(s) 318, memory 320, and/or communication interface 322. Communication interface 322 may be a network interface configured to support communication between computing platform 316 and network(s) 314 (or one or more sub-networks thereof). Memory 320 may include one or more program modules comprising instructions that when executed by processor(s) 318 cause computing platform 316 to perform one or more functions described herein. For example, memory 320 may include program module(s) 326, which may comprise instructions that when executed by processor(s) 318 cause computing platform 316 to perform one or more functions described herein.

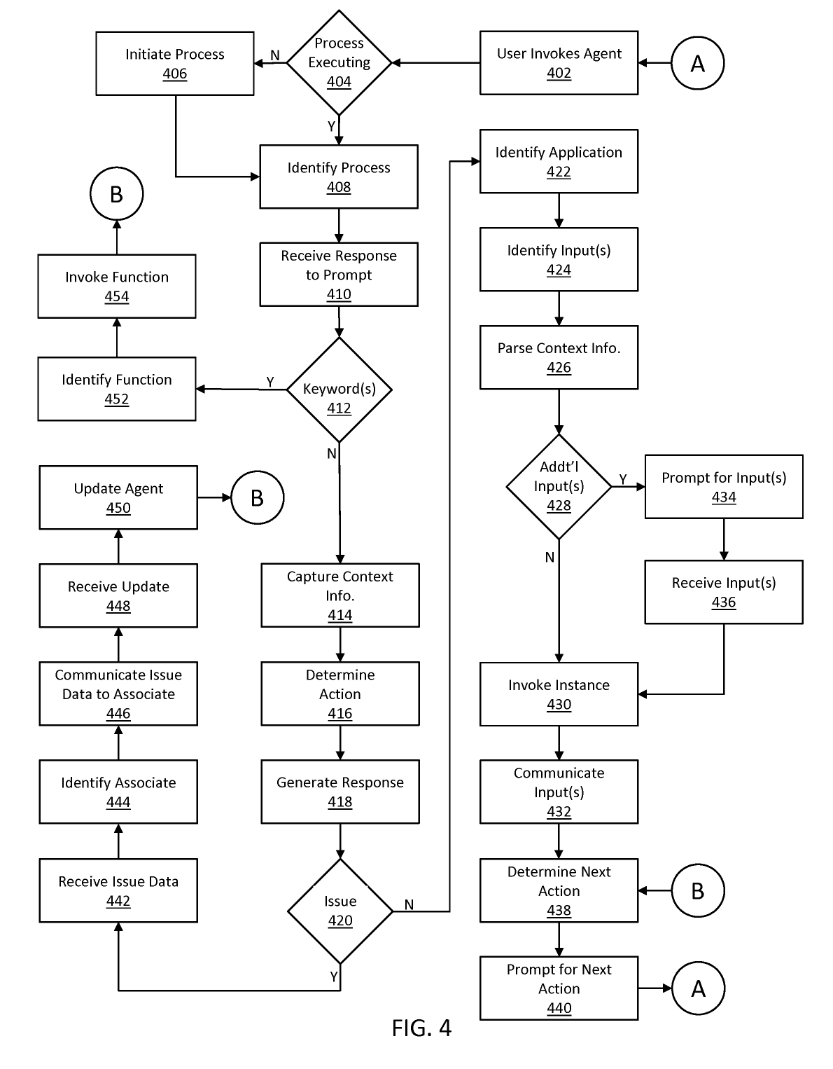

FIG. 4 depicts multiple illustrative methods in accordance with one or more example embodiments. Referring to FIG. 4, at step 402, a user may invoke an automated-dialog agent. For example, a user of user device 302 may invoke an automated-dialog agent utilized by an organization associated with computing environment 300, user device 302 may generate data indicating that the user has invoked the automated-dialog agent and may communicate the data to computing platform 316, which may receive the data (e.g., via communication interface 322). In some embodiments, the automated-dialog agent utilized by the organization associated with computing environment 300 may include a client-side component associated with user device 302 and a server-side component associated with computing platform 316, and the user of user device 302 may have invoked the client-side component associated with user device 302. At step 404, computing platform 316 may determine whether an instance (e.g., a process, object, thread, or the like), of the server-side component associated with computing platform 316, associated with the data (e.g., associated with user device 302, the user of user device 302, the client-side component associated with user device 302, or the like) is executing on computing platform 316 (e.g., on processor(s) 318 and/or in memory 320). Responsive to determining that the instance associated with the data is executing on computing platform 316, at step 408, computing platform 316 may identify the instance associated with the data. Responsive to determining that the instance associated with the data is not executing on computing platform 316, at step 406, computing platform 316 may initiate (e.g., instantiate, execute, schedule, change thread context, or the like) the instance associated with the data, and, at step 408, computing platform 316 may identify the instance associated with the data (e.g., the instance initiated in step 406).

At step 410, computing platform 316 may receive data (e.g., from amongst the data received from user device 302) comprising a natural-language response input by the user of user device 302 (e.g., via the client-side component associated with user device 302) in response to a natural-language prompt generated by the automated-dialog agent (e.g., by the client-side component associated with user device 302 and/or the server-side component associated with computing platform 316). At step 412, computing platform 316 may determine whether the data (e.g., the natural-language response input by the user of user device 302) comprises one or more predetermined keywords associated with the automated-dialog agent. Responsive to determining that the data does not comprise one or more predetermined keywords associated with the automated-dialog agent, at step 414, computing platform 316 may capture contextual information from the data. For example, the data (e.g., the data received from user device 302) may comprise contextual information, and computing platform 316 may capture the contextual information (or a portion thereof), for example, by identifying (e.g., by processing, parsing, analyzing, or the like), from amongst the data, one or more predetermined data elements (e.g., data elements relevant to the organization associated with computing environment 300, user device 302, the automated-dialog agent, one or more applications utilized by the organization associated with computing environment 300, or the like). For example, the organization may be a financial institution, and computing platform 316 may be configured to identify, within the data, one or more predetermined types of numbers (e.g., account numbers), strings (e.g., customer names), or the like. In some embodiments, a graphical user interface (GUI) element associated with the client-side component associated with user device 302 may be displayed by user device 302. In such embodiments, user device 302 may have displayed the prompt via the GUI element associated with the client-side component associated with user device 302, and the contextual information may comprise information displayed by user device 302 via one or more GUI elements distinct from the GUI element associated with the client-side component associated with user device 302 (e.g., information from GUI elements associated with one or more other applications executing on user device 302).

At step 416, computing platform 316 (e.g., the server-side component associated with computing platform 316) may determine, based on the data, a recommended action for the user of user device 302. At step 418, computing platform 316 (e.g., the server-side component associated with computing platform 316) may generate a natural-language response (e.g., a natural-language response identifying the recommended action) to the natural-language response received in step 410, and computing platform 316 may communicate the natural-language response (e.g., the natural-language response identifying the recommended action) to user device 302, which may receive and/or display (e.g., via the GUI element associated with the client-side component associated with user device 302) the natural-language response. At step 420, computing platform 316 may determine whether there is an issue (e.g., an issue with the natural-language response and/or the recommended action). Responsive to determining that there is not an issue, at step 422, computing platform 316 may identify (e.g., based on the data, the natural-language response, the recommended action, or the like) an application (e.g., associated with a computing system utilized by the organization associated with computing environment 300) for implementing the recommended action. At step 424, computing platform 316 may identify a plurality of inputs to the application for implementing the recommended action. At step 426, computing platform 316 may parse the contextual information (e.g., the contextual information captured and/or analyzed in step 414) to identify at least a portion of the plurality of inputs.

At step 428, computing platform 316 may determine whether one or more inputs, from amongst the plurality of inputs (e.g., the inputs to the application for implementing the recommended action), are not included in the at least a portion of the plurality of inputs (e.g., the input(s) identified by parsing the contextual information in step 426). Responsive to determining that one or more inputs, from amongst the plurality of inputs (e.g., the inputs to the application for implementing the recommended action), are not included in the at least a portion of the plurality of inputs (e.g., the input(s) identified by parsing the contextual information in step 426), at step 434, computing platform 316 may identify the input(s) that are not included (e.g., one or more additional inputs for implementing the recommended action) and, at step 436, may generate a natural-language prompt for the input(s) and may communicate the natural-language prompt for the input(s) to user device 302, which may display (e.g., via the GUI element associated with the client-side component associated with user device 302) the natural-language prompt for the input(s). Responsive to the prompt, the user of user device 302 may input the input(s) (e.g., via the client-side component associated with user device 302), and user device 302 may communicate the input(s) to computing platform 316, which, at step 436, may receive the input(s) from user device 302 (e.g., from the client-side component).

Returning to step 428, responsive to determining that the plurality of inputs (e.g., the inputs to the application for implementing the recommended action), are included in the at least a portion of the plurality of inputs (e.g., the input(s) identified by parsing the contextual information in step 426), computing platform 316 may proceed to step 430. At step 430, computing platform 316 may invoke an instance of the application (e.g., for implementing the recommended action). At step 432, computing platform 316 may communicate, to the instance, at least a portion of the plurality of inputs (e.g., one or more of the input(s) identified by parsing the contextual information in step 426 and/or the input(s) received from user device 302 in step 436).

In some embodiments, the application may comprise a terminal-based application hosted by a computing system of computing environment 300. For example, the application may be a terminal-based application hosted by computing system 308. In such embodiments, the automated-dialog agent (e.g., the client-side component associated with user device 302) may input, into a terminal session executing on user device 302 (e.g., a terminal-based application-layer session, such as a telnet session, shell session, secure shell session, or the like), the at least a portion of the plurality of inputs (e.g., one or more of the input(s) identified by parsing the contextual information in step 426 and/or the input(s) received from user device 302 in step 436), and user device 302 may communicate to computing system 308, via the terminal session, the at least a portion of the plurality of inputs.

In some embodiments, the application may comprise a web-based application hosted by a computing system of computing environment 300. For example, the application may be a web-based application hosted by computing system 310. In such embodiments, the automated-dialog agent (e.g., the client-side component associated with user device 302) may input, into a web browser executing on user device 302 (e.g., a web browser navigated to one or more resources, pages, or the like of the web-based application hosted by computing system 310), the at least a portion of the plurality of inputs (e.g., one or more of the input(s) identified by parsing the contextual information in step 426 and/or the input(s) received from user device 302 in step 436), and user device 302 may communicate, to computing system 310, via the web browser, the at least a portion of the plurality of inputs. Additionally or alternatively, computing platform 316 (e.g., the server-side component) may communicate the at least a portion of the plurality of inputs to computing system 310, and computing system 310 may generate a webpage element comprising one or more of the at least a portion of the plurality of inputs and may communicate the webpage element (e.g., a form, application interface, or the like comprising one or more of the at least a portion of the plurality of inputs) to user device 302 (e.g., for display via the web browser executing on user device 302).

In some embodiments, the instance may comprise an application, executing on user device 302, that is in communication with a corresponding application executing on a computing system of computing environment 300. For example, user device 302 may be executing an application (e.g., a client-side application) that is in communication with a corresponding application (e.g., a server-side application) executing on computing system 310. In such embodiments, the automated-dialog agent may communicate (e.g., from the server-side component associated with computing platform 316 to the client-side component associated with user device 302) the at least a portion of the plurality of inputs (e.g., one or more of the input(s) identified by parsing the contextual information in step 426 and/or the input(s) received from user device 302 in step 436), the automated-dialog agent (e.g., the client-side component associated with user device 302) may input the at least a portion of the plurality of inputs into the instance (e.g., the client-side application), which may communicate the at least a portion of the plurality of inputs to the corresponding application (e.g., the server-side application). Computing system 310 (e.g., the server-side application) may generate an interface element comprising one or more of the at least a portion of the plurality of inputs (e.g., a form, application interface, or the like comprising one or more of the at least a portion of the plurality of inputs) and may communicate to user device 302 the interface element (e.g., for display via the client-side application). Additionally or alternatively, the automated-dialog agent (e.g., the server-side component associated with computing platform 316) may communicate the at least a portion of the plurality of inputs to computing system 310. Computing system 310 may input the at least a portion of the plurality of inputs into the corresponding application (e.g., the server-side application), which may generate an interface element comprising one or more of the at least a portion of the plurality of inputs (e.g., a form, application interface, or the like comprising one or more of the at least a portion of the plurality of inputs), and computing system 310 may communicate the interface element to user device 302 (e.g., for display via the client-side application).

In some embodiments, computing environment 300 may include a computing system executing a virtualization platform that hosts a virtual computing environment comprising the instance. For example, computing system 312 may be executing a virtualization platform hosting a virtual computing environment comprising the instance. In such embodiments, the automated-dialog agent (e.g., the server-side component associated with computing platform 316) may communicate the at least a portion of the plurality of inputs (e.g., one or more of the input(s) identified by parsing the contextual information in step 426 and/or the input(s) received from user device 302 in step 436) to computing system 312. The virtualization platform executing on computing system 312 may communicate the at least a portion of the plurality of inputs to the virtual computing environment, and may input, within the virtual computing environment, the at least a portion of the plurality of inputs into the instance. The virtualization platform executing on computing system 312 (e.g., in conjunction with the instance executing within the virtual computing environment) may generate, within the virtual computing environment, an interface element comprising one or more of the at least a portion of the plurality of inputs (e.g., a form, application interface, or the like comprising one or more of the at least a portion of the plurality of inputs), and may generate data comprising a rendering, of at least a portion of the virtual computing environment, comprising the interface element (e.g., a rendering of the virtual computing environment, desktop, portion comprising an interface of the instance, or the like). Computing system 312 may communicate the data comprising the rendering to user device 302 (e.g., for display via an application executing on user device 302 (e.g., an application configured for interacting with the virtual computing environment)).

In some embodiments, the virtual computing environment may comprise a terminal session in communication with a terminal-based application hosted by a different computing system of computing environment 300. For example, the virtual computing environment hosted by the virtualization platform executing on computing system 312 may comprise a terminal session in communication with a terminal-based application hosted by computing system 308. In such embodiments, the at least a portion of the virtual computing environment (e.g., the rendering) may comprise the terminal session, and the virtualization platform executing on computing system 312 may input, within the virtual computing environment, the at least a portion of the plurality of inputs into the terminal session, may communicate, via the terminal session, the at least a portion of the plurality of inputs to computing system 308, and may receive, via the terminal session, the data comprising the one or more of the at least a portion of the plurality of inputs (e.g., data within the rendering) from computing system 308.

In some embodiments, the instance may comprise an application, executing within the virtual computing environment, in communication with a corresponding application executing on a different computing system of computing environment 300. For example, the virtual computing environment hosted by the virtualization platform executing on computing system 312 may comprise an application (e.g., a client-side application) in communication with a corresponding application (e.g., a server-side application) executing on computing system 310. In such embodiments, the at least a portion of the virtual computing environment (e.g., the rendering) may comprise at least a portion of an interface of the application (e.g., the client-side application) in communication with the corresponding application (e.g., the server-side application) executing on computing system 310. The virtualization platform executing on computing system 312 may input, within the virtual computing environment, the at least a portion of the plurality of inputs into the application (e.g., the client-side application) in communication with the corresponding application, may communicate the at least a portion of the plurality of inputs to computing system 310, and may receive, from computing system 310 data, generated by the corresponding application (e.g., the server-side application), comprising the one or more of the at least a portion of the plurality of inputs.

In some embodiments, the automated-dialog agent (e.g., the server-side component associated with computing platform 316 and/or the client-side component associated with user device 302) may generate a natural-language prompt, which may be displayed by user device 302 (e.g., via the GUI element associated with the client-side component), prompting the user of user device 302 to confirm the recommended action (e.g., providing the user with an opportunity to review the instance for implementing the action and/or the inputs to the application). In such embodiments, the automated-dialog agent may receive confirmation from the user and, responsive to receiving the confirmation, may instruct the instance to perform the recommended action.

In some embodiments, the organization associated with computing environment 300 may comprise a financial institution, the user of user device 302 may be an associate of the financial institution, the recommended action may comprise a financial transaction, the instance may be configured to perform the financial transaction, and executing the instance may comprise executing the financial transaction. In such embodiments, the financial transaction may comprise an intra-institution transfer of assets from a first account of the financial institution to a second account of the financial institution, the instance may be configured to transfer the assets from the first account to the second account, and executing the instance may comprise transferring, via the instance, the assets from the first account to the second account. Additionally or alternatively, the financial institution may comprise a brokerage, the user of user device 302 may be a securities broker, the financial transaction may comprise an exchange of assets comprising securities, the instance may be configured to execute the exchange, and executing the instance may comprise executing the exchange.

At step 438, computing platform 316 (e.g., the server-side component) may determine a recommended next action for the user associated with user device 302. For example, in some embodiments, the organization associated with computing environment 300 may comprise a financial institution, the user may be an associate of the financial institution who is responsible for multiple accounts of the financial institution, and the recommended action may comprise an action associated with an account of the multiple accounts. In such embodiments, the recommended next action may comprise an action associated with the account. Additionally or alternatively, the recommended next action may comprise an action associated with a different account of the multiple accounts. At step 440, computing platform 316 (e.g., the server-side component) may generate a natural-language prompt identifying the recommended next action and may communicate the natural-language prompt identifying the recommended next action to user device 302 (e.g., for display via the GUI element associated with the client-side component). The computing platform may then return to step 402 to await data indicating invocation of the automated-dialog agent (e.g., by the user of user device 302 and/or one or more other users of computing environment 300).

Returning to step 420, prior to receiving the data from user device 302 (e.g., as described with respect to step 402 above), computing platform 316 may have received, from user device 304, data indicating that a user of user device 304 (e.g., a different user of computing environment 300) had invoked the automated-dialog agent. The data received from user device 304 may have comprised a natural-language response (e.g., a natural-language response input by the user of user device 304) similar to the natural-language response received from user device 302 (e.g., as described with respect to step 402 above), and computing platform 316 may have performed steps 408, 410, 412, 414, 416, and 418 with respect to the data received from user device 304, and, at step 420, may have determined (e.g., based on data received from user device 304) that there was an issue with the recommended action (e.g., the recommended action determined in step 416 with respect to the data received from user device 304) and/or the natural-language response (e.g., the natural-language response generated in step 418 with respect to the data received from user device 304). Responsive to determining that there was an issue, computing platform 316 may have received, in step 442, data comprising information identifying the issue, which may include a transcript generated by the automated-dialog agent (e.g., a transcript comprising the recommended action (e.g., the recommended action determined in step 416 with respect to the data received from user device 304) and/or the natural-language response (e.g., the natural-language response generated in step 418 with respect to the data received from user device 304)).

At step 444, computing platform 316 may have identified (e.g., based on the user associated with user device 304, user device 304, the recommended action (e.g., the recommended action determined in step 416 with respect to the data received from user device 304) and/or the natural-language response (e.g., the natural-language response generated in step 418 with respect to the data received from user device 304), or the like) user device 306 as associated with an associate of the organization (e.g., a relevant technical associate, a subject-matter expert, a manager of the user associated with user device 304, or the like) and, at step 446, may have communicated the data comprising the information identifying the issue to user device 306. At step 448, computing platform 316 may receive an update to the automated-dialog agent (e.g., an update related to the recommended action (e.g., the recommended action determined in step 416 with respect to the data received from user device 304) and/or the natural-language response (e.g., the natural-language response generated in step 418 with respect to the data received from user device 304), and/or an update configured to address the issue) from user device 306. At step 450, computing platform 316 may have updated the automated-dialog agent in accordance with the update (e.g., to address the issue), and may have proceeded to step 438 to determine a next action for the user associated with user device 304. For example, the natural-language response (e.g., the natural-language response generated in step 418 with respect to the data received from user device 304) and/or the recommended action (e.g., the recommended action determined in step 416 with respect to the data received from user device 304) may have comprised an invalid link (e.g., uniform resource locator (URL)), the update may have comprised a replacement link, and computing platform 316 may have replaced the invalid link with the replacement link. Referring back to step 416 with respect to the data received from user device 302 in step 402, computing platform 316 may have determined, based on the update, the recommended action for the user of user device 302. Referring back to step 418 with respect to the data received from user device 302 in step 402, computing platform 316 may have generated, based on the update, the natural-language response to the natural-language response received from user device 302 in step 410.

Returning to step 412 with respect to the data received from user device 302 in step 402, responsive to determining that the data does comprise one or more predetermined keywords associated with the automated-dialog agent, computing platform 316 may identify the keyword(s) and, at step 452, may identify a function of the automated-dialog agent corresponding to at least one of the keyword(s) and, at step 454, may invoke the function (e.g., via the client-side component associated with user device 302). For example, the keyword(s) may correspond to a live-agent function of the automated-dialog agent, and computing platform 316 may identify, based on the keyword(s) the live-agent function and may invoke the live-agent function, for example, by establishing a communication session with user device 306 (e.g., which may be associated with one or more support personnel of the organization) and inserting dialog (e.g., based on data received via the communication session with user device 306) into one or more natural-language responses generated by the automated-dialog agent. Computing platform 316 may then return to step 438 to determine a next action for the user associated with user device 302.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform associated with an organization, the computing platform comprising at least one processor, a communication interface, and a memory:
instantiating, by the at least one processor, a server-side component of an automated-dialog agent;
receiving, via the communication interface and from a user device, data indicating that a user has invoked a client-side component of the automated-dialog agent, the data comprising contextual information displayed by the user device via one or more graphical user interface (GUI) elements distinct from a GUI element associated with the client-side component, and the data comprising a natural-language response input by the user, via the client-side component, in response to a natural-language prompt generated by the automated-dialog agent and displayed by the user device via the GUI element associated with the client-side component;
responsive to receiving the data:
identifying, by the at least one processor and based on the data, the server-side component;
determining, by the server-side component and based on the data, a recommended action for the user;
generating, by the server-side component and based on the data, a natural-language response to the natural-language response input by the user, the natural-language response to the natural-language response input by the user identifying the recommended action;
identifying, by the server-side component and based on the data, an application, of the organization, for implementing the recommended action, the application executing on a computing system distinct from both the user device and the computing platform;
identifying, by the server-side component, a plurality of inputs, to the application, for implementing the recommended action;
parsing, by the server-side component, the contextual information, to identify at least a portion of the plurality of inputs;
invoking, by the server-side component, an instance, of the application, for implementing the recommended action;
communicating, via the communication interface, by the server-side component, and to the instance, the at least a portion of the plurality of inputs; and
communicating, by the server-side component, to the client-side component, and for display by the user device via the GUI element associated with the client-side component, the natural-language response to the natural-language response input by the user; and
after invoking the instance:
determining, by the server-side component, a recommended next action for the user;
generating, by the server-side component, a natural-language prompt identifying the recommended next action; and
communicating, by the server-side component, to the client-side component, and for display by the user device via the GUI element associated with the client-side component, the natural-language prompt identifying the recommended next action.

2. The method of claim 1, comprising:
identifying, by the server-side component, one or more inputs, from amongst the plurality of inputs, that are not included in the at least a portion of the plurality of inputs;
generating, by the server-side component, a natural-language prompt for the one or more inputs;
communicating, via the communication interface, by the server-side component, to the client-side component, and for display by the user device via the GUI element associated with the client-side component, the natural-language prompt for the one or more inputs;
receiving, via the communication interface, by the server-side component, and from the client-side component, the one or more inputs; and
communicating, via the communication interface, by the server-side component, and to the instance, the one or more inputs.

3. The method of claim 1, comprising:
generating, by the automated-dialog agent and for display by the user device via the GUI element associated with the client-side component, a natural-language prompt prompting the user to confirm the recommended action;
receiving, by the automated-dialog agent, confirmation from the user; and
responsive to receiving the confirmation, instructing, by the automated-dialog agent, the instance to perform the recommended action.

4. The method of claim 1, wherein the application comprises a terminal-based application hosted by the computing system, the method comprising:
inputting, by the client-side component and into a terminal session executing on the user device, the at least a portion of the plurality of inputs; and
communicating, by the user device, to the computing system, and via the terminal session, the at least a portion of the plurality of inputs.

5. The method of claim 1, wherein the application comprises a web-based application hosted by the computing system, the method comprising:
inputting, by the client-side component and into a web browser executing on the user device, the at least a portion of the plurality of inputs; and
communicating, by the user device, to the computing system, and via the web browser, the at least a portion of the plurality of inputs.

6. The method of claim 1, wherein the application comprises a web-based application hosted by the computing system, the method comprising:
communicating, via the communication interface, by the server-side component, and to the computing system, the at least a portion of the plurality of inputs;
generating, by the computing system, a webpage element comprising one or more of the at least a portion of the plurality of inputs; and
communicating, by the computing system, to the user device, and for display via a web browser executing on the user device, the webpage element.

7. The method of claim 1, wherein the instance comprises an application, executing on the user device, in communication with a corresponding application executing on the computing system, the method comprising:
communicating, via the communication interface, by the server-side component, and to the client-side component, the at least a portion of the plurality of inputs;
inputting, by the client-side component and into the instance, the at least a portion of the plurality of inputs;
communicating, by the instance and to the corresponding application, the at least a portion of the plurality of inputs;
generating, by the corresponding application, an interface element comprising one or more of the at least a portion of the plurality of inputs; and
communicating, by the computing system, to the user device, and for display via the instance, the interface element.

8. The method of claim 1, wherein the instance comprises an application, executing on the user device, in communication with a corresponding application executing on the computing system, the method comprising:
communicating, via the communication interface, by the server-side component, and to the computing system, the at least a portion of the plurality of inputs;
inputting, by the computing system and into the corresponding application, the at least a portion of the plurality of inputs;
generating, by the corresponding application, an interface element comprising one or more of the at least a portion of the plurality of inputs; and
communicating, by the computing system, to the user device, and for display via the instance, the interface element.

9. The method of claim 1, wherein the computing system comprises a virtualization platform hosting a virtual computing environment comprising the instance, the method comprising:
communicating, via the communication interface, by the server-side component, and to the computing system, the at least a portion of the plurality of inputs;
communicating, by the virtualization platform and to the virtual computing environment, the at least a portion of the plurality of inputs;
inputting, within the virtual computing environment and into the instance, the at least a portion of the plurality of inputs;
generating, by the virtualization platform and within the virtual computing environment, an interface element comprising one or more of the at least a portion of the plurality of inputs;
generating, by the virtualization platform, data comprising a rendering, of at least a portion of the virtual computing environment, comprising the interface element; and
communicating, by the computing system, to the user device, and for display via an application executing on the user device, the data comprising the rendering.

10. The method of claim 9, wherein the virtual computing environment comprises a terminal session in communication with a terminal-based application hosted by a different computing system, the different computing system being distinct from the computing platform, the user device, and the computing system, and wherein the at least a portion of the virtual computing environment comprises the terminal session, the method comprising:
inputting, into the terminal session, the at least a portion of the plurality of inputs;
communicating, by the virtualization platform, to the different computing system, and via the terminal session, the at least a portion of the plurality of inputs; and
receiving, by the virtualization platform, from the different computing system, and via the terminal session, data comprising the one or more of the at least a portion of the plurality of inputs.

11. The method of claim 9, wherein the instance comprises an application, executing within the virtual computing environment, in communication with a corresponding application executing on a different computing system, the different computing system being distinct from the computing platform, the user device, and the computing system, and wherein the at least a portion of the virtual computing environment comprises at least a portion of an interface of the application in communication with the corresponding application, the method comprising:
inputting, into the application in communication with the corresponding application, the at least a portion of the plurality of inputs;
communicating, by the virtualization platform and to the different computing system, the at least a portion of the plurality of inputs; and
receiving, by the virtualization platform and from the different computing system, data, generated by the corresponding application, comprising the one or more of the at least a portion of the plurality of inputs.

12. The method of claim 1, comprising, prior to receiving the data:
receiving, via the communication interface and from a different user device, data comprising a similar natural-language response, the similar natural-language response having been input, via the different user device, by a different user;
determining, by the at least one processor and based on the data comprising the similar natural-language response, a recommended action for the different user;
generating, by the at least one processor and based on the data comprising the similar natural-language response, a natural-language response to the similar natural-language response, the natural-language response to the similar natural-language response identifying the recommended action for the different user; and
receiving, via the communication interface and from the different user device, data comprising information identifying an issue with at least one of the recommended action for the different user or the natural-language response to the similar natural-language response.

13. The method of claim 12, comprising, responsive to receiving the data comprising the information identifying the issue:
communicating, via the communication interface and to a user device associated with an associate of the organization, the data comprising the information identifying the issue;
communicating, via the communication interface and to the user device associated with an associate of the organization, data comprising a transcript, generated by the automated-dialog agent, the transcript comprising the similar natural-language response and the natural-language response to the similar natural-language response; and
receiving, via the communication interface and from the user device associated with the associate of the organization, an update to the automated-dialog agent, the update being related to the at least one of the recommended action for the different user or the natural-language response to the similar natural-language response, and the update being configured to address the issue.

14. The method of claim 13, comprising at least one of:
determining, based on the update, the recommended action for the user; or
generating, based on the update, the natural-language response to the natural-language response input by the user.

15. The method of claim 13, comprising identifying, by the at least one processor and based on at least one of the issue, the recommended action for the different user, the similar natural-language response, or the natural-language response to the similar natural-language response, the user device associated with the associate of the organization.

16. The method of claim 1, comprising:
receiving, via the communication interface and from the user device, data comprising natural-language comprising one or more predetermined keywords associated with the automated-dialog agent;
identifying, by the server-side component, a function, of the automated-dialog agent, corresponding to at least one of the one or more predetermined keywords; and
invoking, by the server-side component and via the client-side component, the function.

17. The method of claim 1, wherein the organization comprises a financial institution, wherein the user comprises an associate, of the financial institution, responsible for multiple accounts of the financial institution, wherein the recommended action comprises an action associated with an account of the multiple accounts, and wherein determining the recommended next action comprises determining a recommended next action comprising an action associated with a different account of the multiple accounts.

18. The method of claim 1, wherein the organization comprises a financial institution, wherein the user comprises an associate, of the financial institution, responsible for multiple accounts of the financial institution, wherein the recommended action comprises an action associated with an account of the multiple accounts, and wherein determining the recommended next action comprises determining a recommended next action comprising an action associated with the account.

19. An automated-dialog system, comprising:
a user device;
a computing system distinct from the user device, the computing system configured to execute an application associated with an organization utilizing the automated-dialog system; and
a computing platform distinct from both the user device and the computing system, the computing platform comprising at least one processor, a communication interface, and a memory storing instructions that when executed by the at least one processor cause the automated-dialog system to:
instantiate a server-side component of an automated-dialog agent;
receive, via the communication interface and from the user device, data indicating that a user has invoked a client-side component of the automated-dialog agent, the data comprising contextual information displayed by the user device via one or more graphical user interface (GUI) elements distinct from a GUI element associated with the client-side component, and the data comprising a natural-language response input by the user, via the client-side component, in response to a natural-language prompt generated by the automated-dialog agent and displayed by the user device via the GUI element associated with the client-side component;
responsive to receiving the data:
identify, based on the data, the server-side component;
determine, by the server-side component and based on the data, a recommended action for the user;
generate, by the server-side component and based on the data, a natural-language response to the natural-language response input by the user, the natural-language response to the natural-language response input by the user identifying the recommended action;
identify, by the server-side component, based on the data, and for implementing the recommended action, the application;
identify, by the server-side component, a plurality of inputs, to the application, for implementing the recommended action;
parse, by the server-side component, the contextual information, to identify at least a portion of the plurality of inputs;
invoke, by the server-side component, an instance, of the application, for implementing the recommended action;
communicate, via the communication interface, by the server-side component, and to the instance, the at least a portion of the plurality of inputs; and
communicate, by the server-side component, to the client-side component, and for display by the user device via the GUI element associated with the client-side component, the natural-language response to the natural-language response input by the user; and
after invoking the instance:
determine, by the server-side component, a recommended next action for the user;
generate, by the server-side component, a natural-language prompt identifying the recommended next action; and
communicate, by the server-side component, to the client-side component, and for display by the user device via the GUI element associated with the client-side component, the natural-language prompt identifying the recommended next action.

20. One or more non-transitory computer-readable media having instructions stored thereon that when executed by one or more computers cause the one or more computers to:
receive data comprising a natural-language response input by a user, via a user device, in response to a natural-language prompt generated by the one or more computers;
determine, based on the data, a recommended action for the user;
generate, based on the data, a natural-language response to the natural-language response input by the user, the natural-language response to the natural-language response input by the user identifying the recommended action; and
after communicating, to the user device, the natural-language response to the natural-language response input by the user:
determine a recommended next action for the user;
generate a natural-language prompt identifying the recommended next action; and
communicate, to the user device, the natural-language prompt identifying the recommended next action.
